(19) United States
(12) Patent Application Publication
(10) Pub. No.: US 2026/0170404 A1
(43) Pub. Date: Jun. 18, 2026

(54) INTERACTION PROFILING OF MACHINE LEARNING MODEL LAYERS

(71) Applicant: Red Hat, Inc., Raleigh, NC (US)

(72) Inventors: Leigh Griffin, Waterford (IE); Andrea Cosentino, Milan (IT)

(21) Appl. No.: 18/986,177

(22) Filed: Dec. 18, 2024

(51) Int. Cl. G06N 20/00

(52) U.S. Cl. CPC G06N 20/00

(57) ABSTRACT

Techniques for detecting security threats/vulnerabilities resulting from changes to a machine learning (ML) model during operation are disclosed. An initial interaction graph that maps each component of an ML model to system processes of a host operating system (OS) that the component interacts with may be generated. Changes in the ML model may be monitored and in response to detecting a change in the ML model that meets a magnitude criteria, an updated interaction graph may be generated. The updated interaction graph may map each component of the changed ML model to the system processes of the host OS that the component interacts with. The initial interaction graph and the updated interaction graph are compared to determine an interaction graph delta, and one or more mitigating actions are taken based on the interaction graph delta.

### TECHNICAL FIELD

Aspects of the present disclosure relate to machine learning models, and specifically to detecting security threats/vulnerabilities that may arise due to the evolution of a machine learning (ML) model during operation.

### BACKGROUND

Machine learning (ML) models are often deployed on computing devices to perform/automate a number of different functions. A ML model may be trained to perform a function(s) using training data and then the trained ML model may be used to make predictions on new data. The process of training a ML model can be seen as a learning process where the ML model is exposed to new, unfamiliar data step by step. At each step, the ML model makes predictions and gets feedback about how accurate its generated predictions were. Once trained, the ML model can be deployed to perform the function it was trained to perform.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram that illustrates an example system, in accordance with some embodiments of the present disclosure.

FIG. 2 is a block diagram illustrating the example system of FIG. 1, executing a watcher program to monitor changes to an ML model, in accordance with some embodiments of the present disclosure.

FIG. 3A is a block diagram illustrating the example system of FIG. 2, with the watcher program generating an updated interaction graph to detect security threats/vulnerabilities that may arise due to the changes to the ML model, in accordance with some embodiments of the present disclosure.

FIG. 3B is a block diagram illustrating the example system of FIG. 2, with the watcher program generating an updated interaction graph to detect security threats/vulnerabilities that may arise due to the changes to the ML model, in accordance with some embodiments of the present disclosure.

FIG. 4 is a flow diagram of a method for detecting security threats/vulnerabilities that may arise due to the evolution of the ML model during operation, in accordance with some embodiments of the present disclosure.

FIG. 5 is a block diagram of an example computing device that may perform one or more of the operations described herein, in accordance with some embodiments of the present disclosure.

### DETAILED DESCRIPTION

ML models often experience rapid growth in terms of complexity and size as they evolve and learn through repeated interactions. This is especially true for certain types of ML models such as large language models (LLMs). At the same time, ML models are not only deployed on devices with massive available computing resources (e.g., super computers), but are also being deployed on everyday computing devices that have relatively much fewer such as desktop and laptop computers, mobile devices (e.g., smart phones), and IoT devices, among others. This creates challenges with respect to efficiency and resource utilization, with inefficient resource utilization resulting in suboptimal performance of an ML model and, in cases involving resource constrained environments (e.g., IoT), preventing deployment of the ML model altogether.

During operation, different components of an ML model may interact with one or more system processes (e.g., systems calls and APIs) of the host OS on which the ML model executes. As the ML model changes during operation, such changes may alter these system process interactions as well as the resource consumption associated with such interactions. For example, changes in the ML model may result in new ML processes which may begin invoking system processes that were not previously invoked. In addition, existing ML processes may begin invoking different/additional system processes than they were previously. These changes can in turn affect the operational efficiency and security of the ML model because it is difficult to predict what processes the ML model will attempt to access and what the resource implications of such accesses would be. Indeed, it is difficult to predict the real-time operational evolution of an ML model, and thus the measurable impact of such evolution.

The present disclosure addresses the above-noted and other deficiencies by providing techniques for detecting at a granular level (e.g., ML model component by ML model component basis), security threats/vulnerabilities and resource consumption issues that may arise due to the evolution of an ML model during operation. An initial interaction graph that maps each component of a machine learning (ML) model to system processes of a host operating system (OS) that the component interacts with may be generated. Changes in the ML model may be monitored and in response to detecting a change in the ML model that meets a magnitude criteria, an updated interaction graph may be generated. The updated interaction graph may map each component of the changed ML model to the system processes of the host OS that the component interacts with. The initial interaction graph and the updated interaction graph are compared to determine an interaction graph delta, and one or more mitigating actions are taken based on the interaction graph delta.

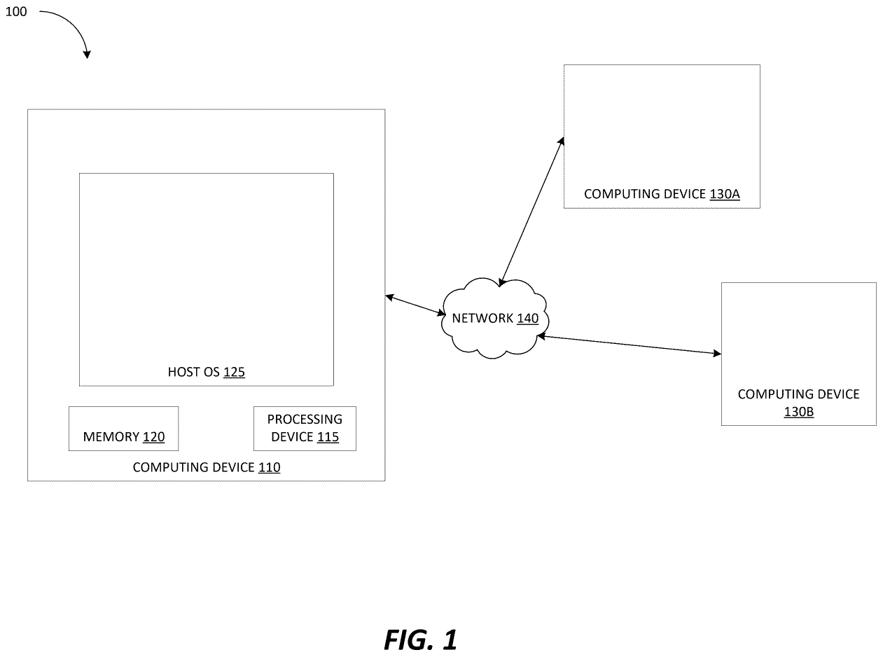

FIG. 1 is a block diagram that illustrates an example system 100. As illustrated in FIG. 1, the system 100 includes a computing device 110, and a plurality of computing devices 130. The computing devices 110 and 130 may be coupled to each other (e.g., may be operatively coupled, communicatively coupled, may communicate data/messages with each other) via network 140. Network 140 may be a public network (e.g., the internet), a private network (e.g., a local area network (LAN) or wide area network (WAN)), or a combination thereof. In one embodiment, network 140 may include a wired or a wireless infrastructure, which may be provided by one or more wireless communications systems, such as a WiFi™ hotspot connected with the network 140 and/or a wireless carrier system that can be implemented using various data processing equipment, communication towers (e.g., cell towers), etc. In some embodiments, the network 140 may be an L3 network. The network 140 may carry communications (e.g., data, message, packets, frames, etc.) between computing device 110 and computing devices 130. Each computing device may include hardware such as processing device 115 (e.g., processors, central processing units (CPUs), memory 120 (e.g., random access memory (RAM), storage devices (e.g., hard-disk drive (HDD), solid-state drive (SSD), etc.)), and other hardware devices (e.g., sound card, video card, etc.). In some embodiments, memory 120 may be a persistent storage that is capable of storing data. A persistent storage may be a local storage unit or a remote storage unit. Persistent storage may be a magnetic storage unit, optical storage unit, solid state storage unit, electronic storage units (main memory), or similar storage unit. Persistent storage may also be a monolithic/single device or a distributed set of devices. Memory 120 may be configured for long-term storage of data and may retain data between power on/off cycles of the computing device 110. Each computing device may comprise any suitable type of computing device or machine that has a programmable processor including, for example, server computers, desktop computers, laptop computers, tablet computers, smartphones, set-top boxes, etc. In some examples, each of the computing devices 110 and 130 may comprise a single machine or may include multiple interconnected machines (e.g., multiple servers configured in a cluster). The computing devices 110 and 130 may be implemented by a common entity/organization or may be implemented by different entities/organizations. For example, computing device 110 may be operated by a first company/corporation and one or more computing devices 130 may be operated by a second company/corporation. Each of computing device 110 and computing devices 130 may execute or include an operating system (OS) such as host OS 125 of computing device 110, as discussed in more detail below. The host OS of a computing device may manage the execution of other components (e.g., software, applications, etc.) and/or may manage access to the hardware (e.g., processors, memory, storage devices etc.) of the computing device.

In some embodiments, the system 100 may be configured as a scalable, distributed computing system, such as a container orchestration platform. A container orchestration platform is a platform for developing and running containerized applications and may allow applications and the data centers that support them to expand from just a few machines and applications to thousands of machines that serve millions of clients. Container orchestration platforms may provide an image-based deployment module for creating containers and may store one or more image files for creating container instances. In some embodiments, the computing device 110 may implement a control plane of a container orchestration platform while computing devices 130 may each implement a compute node of the container orchestration platform. Many application instances can be running in containers on a single host without visibility into each other's processes, files, network, and so on.

The computing devices 130 may be edge devices such as assembly line tools, IoT gateways, points of sale, and industrial controllers that have to operate with limited computing resources, power, cooling, and connectivity. They can also be hard to access, or in settings with little or no on-site technical expertise. In some embodiments, the computing devices 130 may form a domain. A domain may include of a group of devices that share the same configuration, policies, and identity stores. The shared properties allow the devices within the domain to be aware of each other and operate together. The computing devices 130 may all be individual devices that are a part of a domain representing e.g., a fleet of internet of things (IoT) devices.

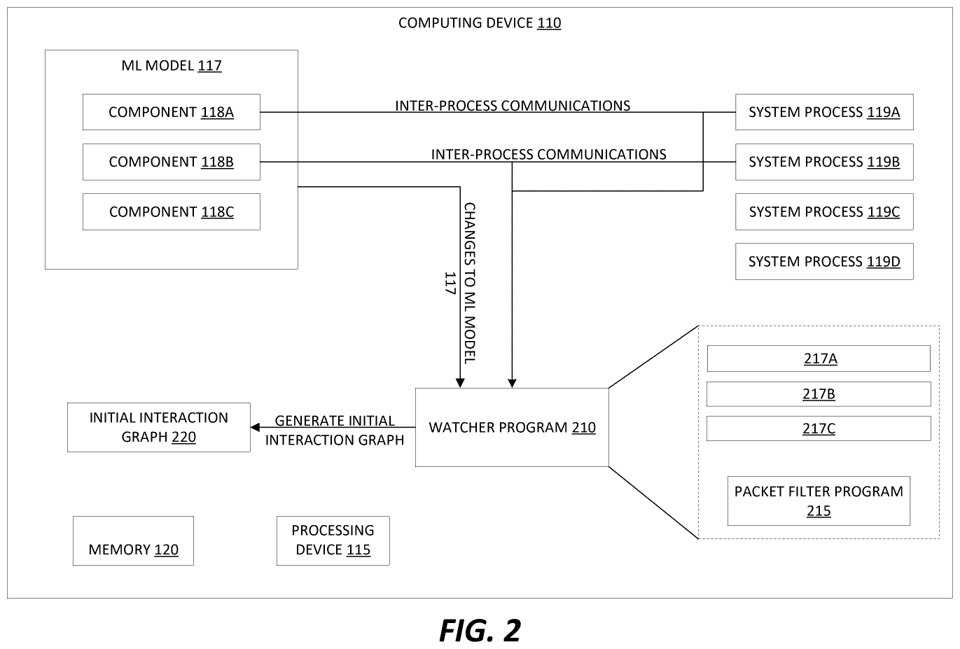

Referring to FIG. 2, the computing device 110 may execute a machine learning (ML) model 117. The ML model 117 may be any appropriate ML model. In addition, the ML model 117 is also shown in FIG. 2 as being executed on computing device 110 for example purposes only and may also be executed on any computing device 130 as a service or part of a service. The ML model 117 may perform functions relating to health care, telecommunications, manufacturing, and autonomous vehicles among others.

The ML model 117 may comprise a number of components 118A-118D. Each component 118 may be a ML process, a layer, or any other appropriate ML model component. Examples of ML processes may include model training, inference, telemetry, prompt optimization, prompt sanitization, and data filtering. Each layer of the ML model 117 may include logic that receives weighted input (e.g., via matrix multiplication between input data and weights), transforms it with an activation function and outputs a non-linear transformation of the input data. The weights are the real values that are attached to each input (i.e., feature) and they convey the importance of that corresponding feature in generating the output. An activation function may comprise a set of functions (which can include non-linear and linear functions). The output of a layer is passed as input to the next layer. The output of the final layer is often referred to as the prediction.

In some embodiments where the ML model 117 is a large language model (LLM), each layer may include one or more attention modules (not shown) that each compute the relationship between different words in an input sequence. Each attention module may comprise an attention head and a feed forward network. While processing a word, an attention head enables the ML model 117 to focus on other words in the input sequence that are closely related to that word. The ML model 117 uses the attention head to relate every word in the input sequence to every other word in the input sequence. The feed forward network of each attention module may forward the output of its corresponding attention head to the attention head of the next attention module.

Each ML process of the ML model 117 may invoke/interact with one or more system processes 119 (e.g., systems calls and APIs) of the host OS 125. The system processes 119 may depend on the environment the computing device 110 is implemented in. For example, if the computing device 110 is implemented in an automotive context, the system processes 119 may relate to vehicle function controls. For example, system process 119A may control the vehicle's heating/air conditioning functions, system process 119B may correspond to the vehicle's global positioning system (GPS)/mapping functionality, system process 119C may correspond to the vehicle's electronic braking functionality, and so on.

As discussed herein, the ML model 117 may continue to experience rapid growth in terms of size and complexity as it continues to evolve and learn through interactions during operation. Changes in the ML model 117 (i.e., the components 118 thereof) may result in changes in the ML model 117's interaction with the system processes 119 and the resource consumption associated with such interactions as discussed in further detail herein. These changes can in turn affect the operational efficiency and security of the ML model 117. For example, the computing device 110/ML model 117 may be deployed in a vehicle to control security functions and may interact with system process 119C which may correspond to the vehicle locking and alarm functionality. In this example, system process 119D may correspond to a discoverable API for controlling the cabin temperature. Over time, if the ML model 117 continually receives queries regarding the temperature of the vehicle, its learning mechanism may spawn a new ML process to begin interacting with the system process 119D (or cause an existing ML process to begin interacting with the system process 119D). As can be seen from the above-example, changes in the ML model 117 over time can result in unexpected and unpredictable behaviors, including interacting with certain system processes 119 that the ML model 117 should not be interacting with. Such unexpected interactions can result in security threats/vulnerabilities as well as increased resource consumption that is beyond an acceptable level.

Embodiments of the present disclosure provide techniques for dynamically monitoring and mapping the interactions between the ML model 117 (i.e., the components thereof) and the system processes 119 based on changes to the ML model 117. This allows for detection of when new components 118 of the ML model 117 have been spawned and the system processes they interact with as well as when existing components 118 have begun interacting with new system processes 119 that they previous did not interact with. These new interactions may be compared to a rule set to take one or more mitigation actions (e.g., role-back of certain changes) as discussed in further detail herein.

Referring now to FIG. 2, the computing device 110 may include a watcher program 210 which may function to monitor the ML model 117 for changes as well as generate interaction graphs as discussed in further detail herein. An interaction graph may specify the various components 118 of the ML model 117, and any system processes 119 that each component 118 of the ML model 117 invokes/interacts with as well as the resource consumption associated with such interactions. The watcher program 210 may include a packet filter program 215 (e.g., the Berkeley packet filter) that assists in generating interaction graphs. The packet filter program 215 may detect ML processes and map those ML processes to systems processes 119 by detecting ML process to system process communications (e.g., inter-process communication calls).

The watcher program 210 may analyze the ML model 117 during an initial state (e.g., prior to operation) and generate an initial interaction graph 220. The initial interaction graph 220 may specify the various components 118 of the ML model 117 during the initial state, and any system processes 119 that each component 118 of the ML model 117 invokes/interacts with in the initial state. The initial interaction graph 220 may also detail the resource consumption associated with each component 118's interaction with a particular system process 119 in the initial state. Thus, the initial interaction graph 220 may be three-dimensional in that it may map each component 118 (e.g., ML process) of the ML model 117 to one or more system processes 119 and to one or more compute resources. In this way, the initial interaction graph 220 can provide for each component 118 of the ML model 117: a detailed view of each particular system process 119 that the component 118 invokes/interacts with as well as the resource impact (CPU impact, memory impact, I/O impact etc.) of the component 118's interaction with each of those particular system processes 119. The system processes 119 may include e.g., systems calls and APIs. As used herein, system calls can include OS level system calls as well as system calls at the user space level where there are other applications running in that cluster/environment.

As the ML model 117 continues to operate, the watcher program 210 will function as a listener style process that monitors changes to the ML model 117 including changes to each individual component 118 thereof. Examples of changes to the ML model 117 may include changes in the model parameters of the ML model 117 including e.g., the weighting of one or more layers of the ML model 117, the biasing of one or more layers of the ML model 117, modifications to a layer's type, the addition of new layers to the ML model 117, and the removal of an existing layer from the ML model 117. The watcher program 210 may monitor for these changes by monitoring a variety of sources including the model parameters of the ML model 117, data repositories of the computing device 110 (e.g., to identify availability of a new data set—which may implicate a retraining of the ML model 117) (including incremental learning), and update mechanisms of the ML model 117.

The watcher program 210 may include a number of listener modules 217 that may each monitor a particular source for changes to the ML model 117. The watcher program 210 may include a model parameter listener module 217A to monitor the model parameters of the ML model 117. For example, the model parameters of the ML model 117 may be defined in a configuration file (not shown) of the ML model 117 and the model parameter listener module may monitor the configuration file for changes. The watcher program 210 may also include a data repository listener module 217B to monitor data set repositories of the computing device 110 to determine whether new data that would trigger a retraining of the ML model 117 has been generated or otherwise obtained. New data that would trigger a retraining of the ML model 117 may include e.g., a new training data set and/or input and output data of the ML model 117 during real time operation. Retraining of the ML model 117 may include a formal retraining phase or an incremental learning process. The watcher program 210 may also include an update mechanism listener module 217C to monitor the ML model 117's update mechanism for feedback loops using e.g., log analysis and API analysis. The logs the watcher program 210 may analyze may include for example, error logs. In addition, the watcher program 210 may analyze timing data to determine how long cycles are taking so that computational resources can be adjusted. Further, the watcher program 210 may analyze convergence data to show whether the model is converging successfully (or diverging, if not). Convergence involves comparing the accuracy of an ML model to a known benchmark. The watcher program 210 may also look at API information from services that support the analysis of these data types (timing data, convergence data, error logs), such as a convergence service (not shown). The watcher program 210 may monitor the ML model 117's feedback loops to detect incremental learning processes occurring in the ML model 117. The feedback loops of the ML model 117 may comprise any appropriate form of learning that the ML model 117 has adopted, including retraining, incremental learning and/or any other appropriate learning method. Each of these listener modules 217 may utilize the packet filter program 215, API monitoring tools, logs, and other tools/information to detect changes in the ML model 117 from the respective source that they monitor.

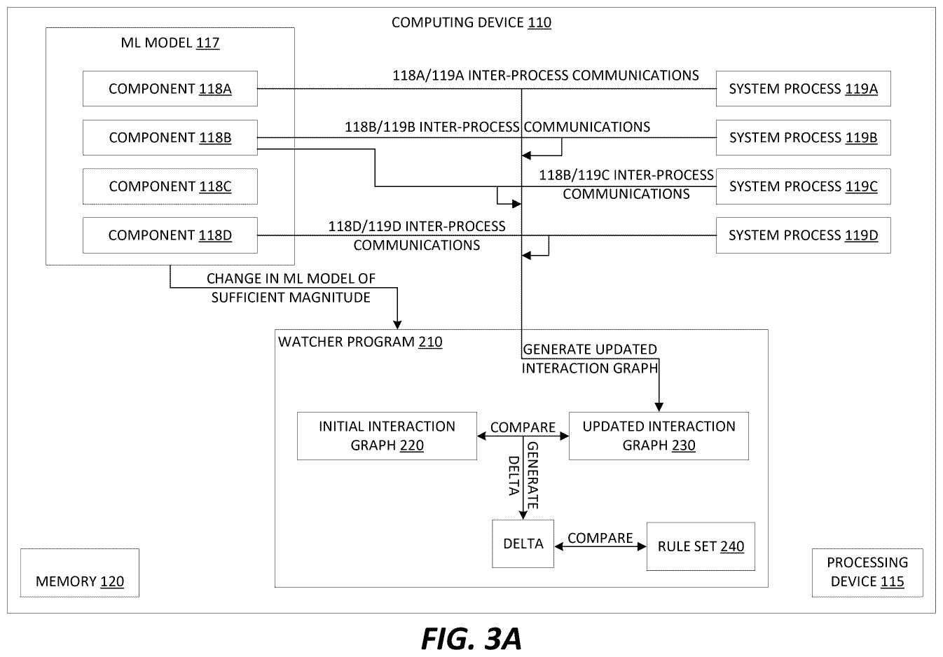

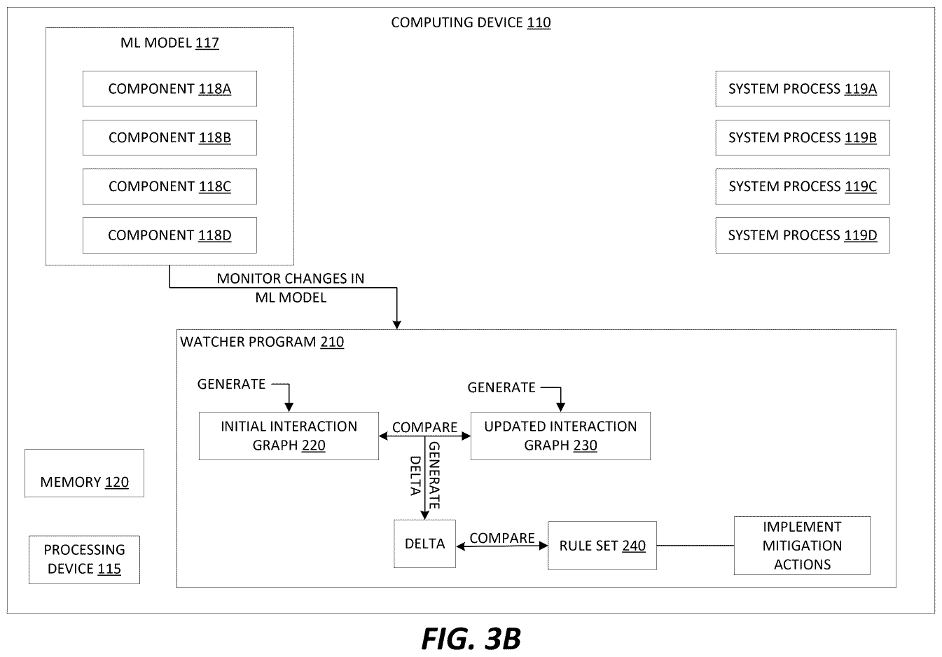

Referring to FIGS. 3A and 3B, when the watcher program 210 detects changes in the ML model 117 of sufficient magnitude has occurred, it may generate an updated interaction graph 230 based on the state of the ML model 117 after the change. The watcher program 210 may only generate the updated interaction graph 230 when a change in the ML model 117 that warrants generation of an updated interaction graph 230 (i.e., a change of sufficient magnitude) is detected. The watcher program 210 may utilize a rule-based approach to provide magnitude criteria for determining whether particular changes to the ML model 117 are of sufficient magnitude. A first example rule may state that a retraining of the ML model 117 (resulting in e.g., a new version of the ML model 117), may be a change of sufficient magnitude. A second example rule may specify thresholds for changes to each of the model parameters of the ML model 117, where a change to a model parameter that exceeds the corresponding threshold is considered to be of sufficient magnitude. For example, a sufficiently large change in the weighting of one or more layers of the ML model 117 or the addition of a new layer/removal of an existing layer from the ML model 117 may constitute a change of sufficient magnitude. A third example rule may specify that where a threshold number of different model parameters have changed, the corresponding threshold of change for each model parameter may be lower than the threshold set by the second rule. It should be noted that a change of sufficient magnitude may be a single change, or multiple changes attributed to a single event (e.g., a multitude of changes resulting from a retraining of the ML model 117).

Upon detecting a change of sufficient magnitude in the ML model 117 has occurred, the watcher program 210 may generate the updated interaction graph 230. The updated interaction graph 230 may indicate the various components 118 of the ML model 117 in its current state (i.e., post-change), the respective system processes 119 that each component 118 invokes/interacts with and the resource impact (CPU impact, memory impact, I/O impact etc.) of each component 118's invocation/interaction with their respective system processes 119.

The watcher program 210 may compare the initial interaction graph 220 and the updated interaction graph 230 and generate an interaction graph delta (also referred to herein as a delta) between them. In this way, as the ML model 117 (including the components 118 thereof) changes, its resource consumption may change and the watcher program 210 may track any such changes in resource consumption. The watcher program 210 may also attribute each change in resource consumption to a change in a particular component 118 of the ML model 117. The watcher program 210 may also track changes in the system processes 119 invoked by the ML model 117 (on a component-by-component basis) as it evolves.

Based on the delta, the watcher program 210 may determine if any new components 118 (e.g., ML model processes) have been spawned by the changes to the ML model 117, what system processes 119 these new components 118 are invoking/interacting with and the changes in resource consumption of the ML model 117 associated with these new interactions. The watcher program 210 may also determine based on the delta, whether existing components 118 are invoking/interacting with any new system processes that they were not previously invoking/interacting with and the changes in resource consumption of the ML model 117 (i.e., resource impact) associated with these new interactions. The watcher program 210 may also determine based on the delta, whether certain previously existing components 118 no longer exist, and the changes in the resource consumption of the ML model 117 associated with the loss of these components 118. In the example of FIGS. 2, 3A and 3B, the watcher program 210 may determine that ML process 118B is now invoking/interacting with system process 119C in addition to system process 119B, and that new ML process 118D has been spawned and is invoking/interacting with system process 119D (as well as the corresponding resource impact of all of these new interactions).

The watcher program 210 may implement a set of rules 240 to determine whether the changes to the ML model 117 pose a security risk and/or exceed resource consumption thresholds. For example, the set of rules 240 may include a first example rule indicating that invocation of certain system processes 119 may not be allowed. For example, system process 119D may correspond to the braking function of the vehicle, and thus unauthorized access may pose a high security risk. Thus, the first example rule may state that interaction with the system process 119D is not allowed. A second example rule may specify a limit on the increase in one or more types of resource consumption that interactions between a single new ML process and a system process 119 can cause. Thus, the second example rule may state that interactions between a single new ML process and a system process 119 cannot cause an increase in CPU consumption of more than e.g., 10% and an increase in memory consumption of more than e.g., 200 MB. A third example rule may specify that certain system calls 119 can only be interacted with on a conditional basis e.g., with a limited set of access rights or with a limited amount of resource consumption. For example, the third example rule may limit an ML process'access rights to files and resources of a system process 119 to read only. As can be seen, the rule set 240 may include rules that specify a variety of access-based and resource consumption-based restrictions on component 118 interactions with system processes 119.

In addition to specifying conditions for invoking/interacting with system calls 119, certain rules of the rule set 240 may also include one or more mitigation actions. For example, the first example rule above may indicate that no component 118 may invoke/interact with system process 119D, but may specify a mitigation action requiring roll back of only the particular change in the ML model 117 that spawned the new ML process 118D. Because the delta generated by the watcher program 210 attributes system process interactions and resource consumption thereof on a component by component basis, such mitigation actions can be specifically targeted to changes/components 118 in the ML model 117 that caused violation of the rule instead of e.g., having to roll back all of the changes resulting from a retraining of the ML model 117. In another example, the second example rule may specify a mitigation action limiting the amount of CPU and memory that can be used by a new ML process invoking/interacting with a system process 119.

The watcher program 210 may compare any new components 118 (e.g., ML model processes) spawned by the changes to the ML model 117, their associated system process 119 interactions and the changes in resource consumption of the ML model 117 associated with these new system process 119 interactions to the rule set 240. The watcher program 210 may also compare any new system process 119 interactions of existing components 118 and the changes in resource consumption of the ML model 117 (i.e., resource impact) associated with these new system process 119 to the rule set 240. Based on these comparisons, the watcher program 210 may take one or more roll back actions accordingly based on the applicable rules of the rule set 240. In this way, embodiments of the present disclosure allow for the detection of security threats/vulnerabilities and resource consumption issues that may arise due to the evolution of an ML model over time during operation. In addition, the embodiments of the present disclosure provide mitigation actions that can balance the desire for growth and development of an ML model with important security and resource consumption policies.

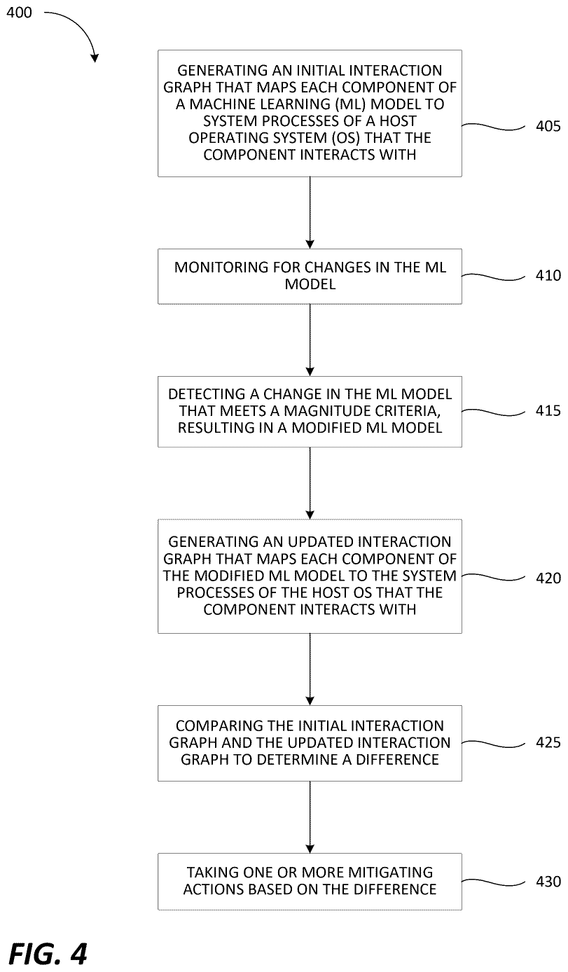

FIG. 4 is a flow diagram of a method 400 for detecting security threats/vulnerabilities and resource consumption issues that may arise due to the evolution of an ML model during operation at a granular (e.g., ML model component by ML model component basis) level, in accordance with some embodiments of the present disclosure. Method 400 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, the method 400 may be performed by a computing device (e.g., computing device 110 illustrated in FIGS. 1-3B).

At block 405, the watcher program 210 may analyze the ML model 117 during an initial state (e.g., prior to operation) and generate an initial interaction graph 220. The initial interaction graph 220 may specify the various components 118 of the ML model 117 during the initial state, and any system processes 119 that each component 118 of the ML model 117 invokes/interacts with in the initial state. The initial interaction graph 220 may also detail the resource consumption associated with each component 118's interaction with a particular system process 119 in the initial state. Thus, the initial interaction graph 220 may be three-dimensional in that it may map each component 118 (e.g., ML process) of the ML model 117 to one or more system processes 119 and to one or more compute resources. In this way, the initial interaction graph 220 can provide for each component 118 of the ML model 117: a detailed view of each particular system process 119 that the component 118 invokes/interacts with as well as the resource impact (CPU impact, memory impact, I/O impact etc.) of the component 118's interaction with each of those particular system processes 119. The system processes 119 may include e.g., systems calls and APIs. As used herein, system calls can include OS level system calls as well as system calls at the user space level where there are other applications running in that cluster/environment.

At block 410, as the ML model 117 continues to operate, the watcher program 210 will function as a listener style process that monitors changes to the ML model 117 including changes to each individual component 118 thereof. Examples of changes to the ML model 117 may include changes in the model parameters of the ML model 117 including e.g., the weighting of one or more layers of the ML model 117, the biasing of one or more layers of the ML model 117, modifications to a layer's type, the addition of new layers to the ML model 117, and the removal of an existing layer from the ML model 117. The watcher program 210 may monitor for these changes by monitoring a variety of sources including the model parameters of the ML model 117, data repositories of the computing device 110 (e.g., to identify availability of a new data set - which may implicate a retraining of the ML model 117) (including incremental learning), and update mechanisms of the ML model 117.

The watcher program 210 may include a number of listener modules 217 that may each monitor a particular source for changes to the ML model 117. The watcher program 210 may include a model parameter listener module 217A to monitor the model parameters of the ML model 117. For example, the model parameters of the ML model 117 may be defined in a configuration file (not shown) of the ML model 117 and the model parameter listener module may monitor the configuration file for changes. The watcher program 210 may also include a data repository listener module 217B to monitor data set repositories of the computing device 110 to determine whether new data that would trigger a retraining of the ML model 117 has been generated or otherwise obtained. New data that would trigger a retraining of the ML model 117 may include e.g., a new training data set and/or input and output data of the ML model 117 during real time operation. Retraining of the ML model 117 may include a formal retraining phase or an incremental learning process. The watcher program 210 may also include an update mechanism listener module 217C to monitor the ML model 117's update mechanism for feedback loops using e.g., log analysis and API analysis. The watcher program 210 may monitor the ML model 117's feedback loops to detect incremental learning processes occurring in the ML model 117. Each of these listener modules 217 may utilize the packet filter program 215, API monitoring tools, logs, and other tools/information to detect changes in the ML model 117 from the respective source that they monitor.

Referring to FIGS. 3A and 3B, at block 415 the watcher program 210 may detect that a change in the ML model 117 of sufficient magnitude has occurred. At block 420, the watcher program 210 may generate an updated interaction graph 230 based on the state of the ML model 117 after the change. The watcher program 210 may only generate the updated interaction graph 230 when a change in the ML model 117 that warrants generation of an updated interaction graph 230 (i.e., a change of sufficient magnitude) is detected. The watcher program 210 may utilize a rule-based approach to provide magnitude criteria for determining whether particular changes to the ML model 117 are of sufficient magnitude. It should be noted that a change of sufficient magnitude may be a single change, or multiple changes attributed to a single event (e.g., a multitude of changes resulting from a retraining of the ML model 117).

Upon detecting a change of sufficient magnitude in the ML model 117 has occurred, the watcher program 210 may generate the updated interaction graph 230. The updated interaction graph 230 may indicate the various components 118 of the ML model 117 in its current state (i.e., post-change), the respective system processes 119 that each component 118 invokes/interacts with and the resource impact (CPU impact, memory impact, I/O impact etc.) of each component 118's invocation/interaction with their respective system processes 119.

At block 425, the watcher program 210 may compare the initial interaction graph 220 and the updated interaction graph 230 and generate an interaction graph delta (also referred to herein as a delta) between them. In this way, as the ML model 117 (including the components 118 thereof) changes, its resource consumption may change and the watcher program 210 may track any such changes in resource consumption. The watcher program 210 may also attribute each change in resource consumption to a change in a particular component 118 of the ML model 117. The watcher program 210 may also track changes in the system processes 119 invoked by the ML model 117 (on a component-by-component basis) as it evolves.

Based on the delta, the watcher program 210 may determine if any new components 118 (e.g., ML model processes) have been spawned by the changes to the ML model 117, what system processes 119 these new components 118 are invoking/interacting with and the changes in resource consumption of the ML model 117 associated with these new interactions. The watcher program 210 may also determine based on the delta, whether existing components 118 are invoking/interacting with any new system processes that they were not previously invoking/interacting with and the changes in resource consumption of the ML model 117 (i.e., resource impact) associated with these new interactions. The watcher program 210 may also determine based on the delta, whether certain previously existing components 118 no longer exist, and the changes in the resource consumption of the ML model 117 associated with the loss of these components 118. In the example of FIGS. 2 and 3A, the watcher program 210 may determine that ML process 118B is now invoking/interacting with system process 119C in addition to system process 119B, and that new ML process 118D has been spawned and is invoking/interacting with system process 119D (as well as the corresponding resource impact of all of these new interactions).

The watcher program 210 may implement a set of rules 240 to determine whether the changes to the ML model 117 pose a security risk and/or exceed resource consumption thresholds. For example, the set of rules 240 may include a first example rule indicating that invocation of certain system processes 119 may not be allowed. For example, system process 119D may correspond to the braking function of the vehicle, and thus unauthorized access may pose a high security risk. Thus, the first example rule may state that interaction with the system process 119D is not allowed. A second example rule may specify a limit on the increase in one or more types of resource consumption that interactions between a single new ML process and a system process 119 can cause. Thus, the second example rule may state that interactions between a single new ML process and a system process 119 cannot cause an increase in CPU consumption of more than e.g., 10% and an increase in memory consumption of more than e.g., 200 MB. A third example rule may specify that certain system calls 119 can only be interacted with on a conditional basis e.g., with a limited set of access rights or with a limited amount of resource consumption. For example, the third example rule may limit an ML process'access rights to files and resources of a system process 119 to read only. As can be seen, the rule set 240 may include rules that specify a variety of access-based and resource consumption-based restrictions on component 118 interactions with system processes 119.

In addition to specifying conditions for invoking/interacting with system calls 119, certain rules of the rule set 240 may also include one or more mitigation actions. For example, the first example rule above may indicate that no component 118 may invoke/interact with system process 119D, but may specify a mitigation action requiring roll back of only the particular change in the ML model 117 that spawned the new ML process 118D. Because the delta generated by the watcher program 210 attributes system process interactions and resource consumption thereof on a component by component basis, such mitigation actions can be specifically targeted to changes/components 118 in the ML model 117 that caused violation of the rule instead of e.g., having to roll back all of the changes resulting from a retraining of the ML model 117. In another example, the second example rule may specify a mitigation action limiting the amount of CPU and memory that can be used by a new ML process invoking/interacting with a system process 119.

The watcher program 210 may compare any new components 118 (e.g., ML model processes) spawned by the changes to the ML model 117, their associated system process 119 interactions and the changes in resource consumption of the ML model 117 associated with these new system process 119 interactions to the rule set 240. The watcher program 210 may also compare any new system process 119 interactions of existing components 118 and the changes in resource consumption of the ML model 117 (i.e., resource impact) associated with these new system process 119 to the rule set 240. At block 430, based on these comparisons the watcher program 210 may take one or more roll back actions accordingly based on the applicable rules of the rule set 240. In this way, embodiments of the present disclosure allow for the detection of security threats/vulnerabilities and resource consumption issues that may arise due to the evolution of an ML model over time during operation. In addition, the embodiments of the present disclosure provide mitigation actions that can balance the desire for growth and development of an ML model with important security and resource consumption policies.

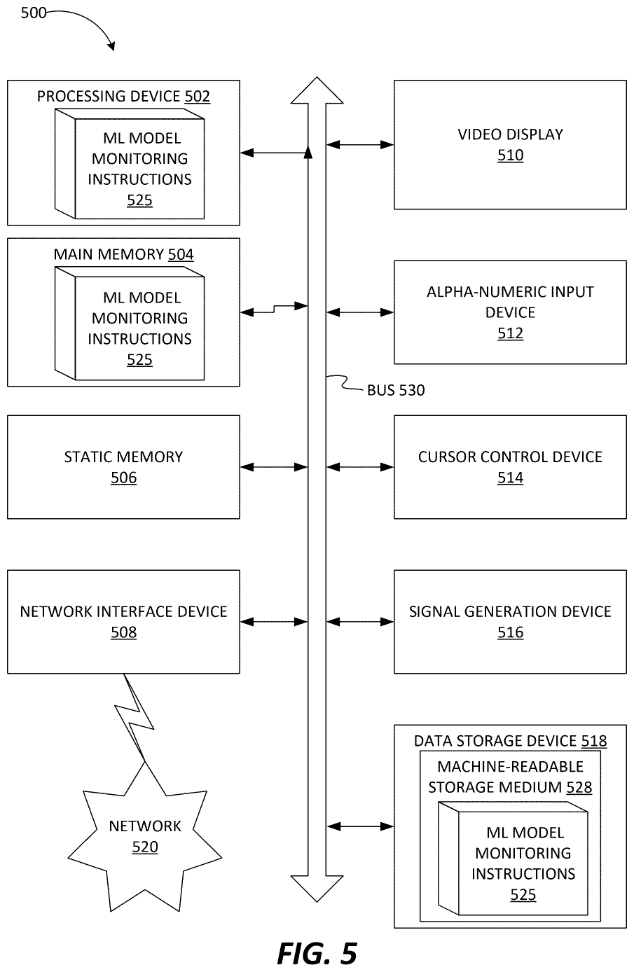

FIG. 5 illustrates a diagrammatic representation of a machine in the example form of a computer system 500 within which a set of instructions, for causing the machine to perform any one or more of the methodologies discussed herein. In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one embodiment, computer system 500 may be representative of a server.

The exemplary computer system 500 includes a processing device 502, a main memory 504 (e.g., read-only memory (ROM), flash memory, dynamic random access memory (DRAM), a static memory 506 (e.g., flash memory, static random access memory (SRAM), etc.), and a data storage device 518, which communicate with each other via a bus 530. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Computing device 500 may further include a network interface device 508 which may communicate with a network 520. The computing device 500 also may include a video display unit 510 (e.g., a liquid crystal display (LCD) or a cathode ray tube (CRT)), an alphanumeric input device 512 (e.g., a keyboard), a cursor control device 514 (e.g., a mouse) and an acoustic signal generation device 516 (e.g., a speaker). In one embodiment, video display unit 510, alphanumeric input device 512, and cursor control device 514 may be combined into a single component or device (e.g., an LCD touch screen).

Processing device 502 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 502 may also be one or more special-purpose processing devices such as an application specific integrated circuit (ASIC), a field programmable gate array (FPGA), a digital signal processor (DSP), network processor, or the like. The processing device 502 is configured to execute ML model monitoring instructions 525, for performing the operations and steps discussed herein.

The data storage device 518 may include a machine-readable storage medium 528, on which is stored one or more sets of ML model monitoring instructions 525 (e.g., software) embodying any one or more of the methodologies of functions described herein. The ML model monitoring instructions 525 may also reside, completely or at least partially, within the main memory 504 or within the processing device 502 during execution thereof by the computer system 500; the main memory 504 and the processing device 502 also constituting machine-readable storage media. The ML model monitoring instructions 525 may further be transmitted or received over a network 520 via the network interface device 508.

The machine-readable storage medium 528 may also be used to store instructions to perform a method for assigning tasks using an automation controller. While the machine-readable storage medium 528 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Unless specifically stated otherwise, terms such as “generating,” “monitoring,” “detecting,” “comparing,” “taking” and the like refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method comprising:
generating an initial interaction graph that maps each component of a machine learning (ML) model to system processes of a host operating system (OS) that the component interacts with;
monitoring for changes in the ML model;
detecting a change in the ML model that meets a magnitude criteria, resulting in a modified ML model;
generating an updated interaction graph that maps each component of the modified ML model to the system processes of the host OS that the component interacts with;
comparing, by a processing device, the initial interaction graph and the updated interaction graph to determine an interaction graph delta; and
taking one or more mitigating actions based on the interaction graph delta.

2. The method of claim 1, wherein monitoring for changes in the ML model comprises monitoring for: changes in a weighting of one or more layers of the ML model, changes in a biasing of one or more layers of the ML model, modifications to a type of one or more layers of the ML model, addition of one or more new layers to the ML model, and removal of one or more existing layers from the ML model.

3. The method of claim 1, wherein monitoring for changes in the ML model comprises:
monitoring a configuration file of the ML model for changes to model parameters of the ML model;
monitoring one or more data repositories for data used to retrain the ML model; and
monitoring an update mechanism of the ML model to detect changes in the ML model based on incremental learning.

4. The method of claim 1, wherein the components of the ML model comprise ML processes and layers.

5. The method of claim 4, further comprising:
determining, based on the interaction graph delta:
one or more new ML processes generated as a result of the change in the ML model and system process interactions of each of the one or more new ML processes;
changes in resource consumption of the ML model associated with the system process interactions of each of the one or more new ML processes;
changes in system process interactions of one or more of the components of the ML model; and
changes in resource consumption of the ML model associated with the changes in system process interactions of the one or more of the components of the ML model.

6. The method of claim 5, further comprising:
performing a first comparison of the system process interactions of each of the one or more new ML processes with a set of rules;
performing a second comparison of the changes in resource consumption of the ML model associated with the system process interactions of each of the one or more new ML processes with the set of rules; and
performing a third comparison of the changes in resource consumption of the ML model associated with the changes in system process interactions of the one or more of the components of the ML model with the set of rules, wherein the one or more mitigating actions are based on the first second and third comparisons.

7. The method of claim 1, wherein the ML model is a large language model (LLM).

8. A system comprising:
a memory; and
a processing device operatively coupled to the memory, the processing device to:
generate an initial interaction graph that maps each component of a machine learning (ML) model to system processes of a host operating system (OS) that the component interacts with;
monitor for changes in the ML model;
detect a change in the ML model that meets a magnitude criteria, resulting in a modified ML model;
generate an updated interaction graph that maps each component of the modified ML model to the system processes of the host OS that the component interacts with;
compare the initial interaction graph and the updated interaction graph to determine an interaction graph delta; and
take one or more mitigating actions based on the interaction graph delta.

9. The system of claim 8, wherein to monitor for changes in the ML model, the processing device is to monitor for: changes in a weighting of one or more layers of the ML model, changes in a biasing of one or more layers of the ML model, modifications to a type of one or more layers of the ML model, addition of one or more new layers to the ML model, and removal of one or more existing layers from the ML model.

10. The system of claim 8, wherein to monitor for changes in the ML model, the processing device is to:
monitor a configuration file of the ML model for changes to model parameters of the ML model;
monitor one or more data repositories for data used to retrain the ML model; and
monitor an update mechanism of the ML model to detect changes in the ML model based on incremental learning.

11. The system of claim 8, wherein the components of the ML model comprise ML processes and layers.

12. The system of claim 11, wherein the processing device is further to:
determine, based on the interaction graph delta:
one or more new ML processes generated as a result of the change in the ML model and system process interactions of each of the one or more new ML processes;
changes in resource consumption of the ML model associated with the system process interactions of each of the one or more new ML processes;
changes in system process interactions of one or more of the components of the ML model; and
changes in resource consumption of the ML model associated with the changes in system process interactions of the one or more of the components of the ML model.

13. The system of claim 12, wherein the processing device is further to:
perform a first comparison of the system process interactions of each of the one or more new ML processes with a set of rules;
perform a second comparison of the changes in resource consumption of the ML model associated with the system process interactions of each of the one or more new ML processes with the set of rules; and
perform a third comparison of the changes in resource consumption of the ML model associated with the changes in system process interactions of the one or more of the components of the ML model with the set of rules, wherein the one or more mitigating actions are based on the first, second and third comparisons.

14. The system of claim 8, wherein the ML model is a large language model (LLM).

15. A non-transitory computer-readable medium having instructions stored thereon which, when executed by a processing device, cause the processing device to:
generate an initial interaction graph that maps each component of a machine learning (ML) model to system processes of a host operating system (OS) that the component interacts with;
monitor for changes in the ML model;
detect a change in the ML model that meets a magnitude criteria, resulting in a modified ML model;
generate an updated interaction graph that maps each component of the modified ML model to the system processes of the host OS that the component interacts with;
compare, by the processing device, the initial interaction graph and the updated interaction graph to determine an interaction graph delta; and
take one or more mitigating actions based on the interaction graph delta.

16. The non-transitory computer-readable medium of claim 15, wherein to monitor for changes in the ML model, the processing device is to monitor for: changes in a weighting of one or more layers of the ML model, changes in a biasing of one or more layers of the ML model, modifications to a type of one or more layers of the ML model, addition of one or more new layers to the ML model, and removal of one or more existing layers from the ML model.

17. The non-transitory computer-readable medium of claim 15, wherein to monitor for changes in the ML model, the processing device is to:
monitor a configuration file of the ML model for changes to model parameters of the ML model;
monitor one or more data repositories for data used to retrain the ML model; and
monitor an update mechanism of the ML model to detect changes in the ML model based on incremental learning.

18. The non-transitory computer-readable medium of claim 15, wherein the components of the ML model comprise ML processes and layers.

19. The non-transitory computer-readable medium of claim 18, wherein the processing device is further to:
determine, based on the interaction graph delta:
one or more new ML processes generated as a result of the change in the ML model and system process interactions of each of the one or more new ML processes;
changes in resource consumption of the ML model associated with the system process interactions of each of the one or more new ML processes;
changes in system process interactions of one or more of the components of the ML model; and
changes in resource consumption of the ML model associated with the changes in system process interactions of the one or more of the components of the ML model.

20. The non-transitory computer-readable medium of claim 19, wherein the processing device is further to:
perform a first comparison of the system process interactions of each of the one or more new ML processes with a set of rules;
perform a second comparison of the changes in resource consumption of the ML model associated with the system process interactions of each of the one or more new ML processes with the set of rules; and
perform a third comparison of the changes in resource consumption of the ML model associated with the changes in system process interactions of the one or more of the components of the ML model with the set of rules, wherein the one or more mitigating actions are based on the first, second and third comparisons.
